(19) United States
(12) Patent Application Publication
(10) Pub. No.: US 2011/0187117 A1
(43) Pub. Date: Aug. 4, 2011

(54) SUBSTANTIALLY SPHERICAL MULTI-BLADE WIND TURBINE

(75) Inventors: Joseph Hess, Bevaix (CH); Myriam Muller, Bevaix (CH); Stephane Fiorucci, Sonvilier (CH); Eric Marguet, Les Combes (FR)

(73) Assignee: SYNEOLA SA, Peseux, CH (CH)

(21) Appl. No.: 12/995,123

(22) PCT Filed: May 26, 2009
(86) PCT No.: PCT/EP09/56376

§ 371 Date: Apr. 20, 2011

(30) Foreign Application Priority Data
May 27, 2008 (EP) 08156970.9

(51) Int. Cl. F03D 9/00; F03D 3/06; F03D 11/02

(52) U.S. Cl. 290/55; 416/151; 416/223 R

(57) ABSTRACT

A substantially spherical multi-blade wind turbine (SSMBWT) includes: (a) a plurality of multifunctional blades (2); and (b) a rotating axis (3) configured to rotate when the blades capture wind and for coupling to a power generator (4a), wherein each multifunctional blade (2) comprises three integrated functional sections (2a, 2b, 2c), wherein each functional section has a different shape and is configured to guide and evacuate incoming airflow and to capture wind energy from different anisotropic directions, ranging from around to above and below the body of the substantially spherical multi-blade wind turbine (SSMBWT).

This is a National Phase Application in the United States of International Patent Application No. PCT/EP2009/056376 filed May 26, 2009, which claims priority on European Patent Application No. 08156970.9, filed May 27, 2008. The entire disclosures of the above patent applications are hereby incorporated by reference.

### FIELD OF THE INVENTION

### Introduction

The present invention provides an integrated small to medium scale, decentralized electrical power generation system deriving electrical power from at least one local renewable energy source and addressing individual efficiency, ubiquity and network integration problems posed by such locally as embedded systems. The application field of the invention addresses the needs for innovation such integrated small to medium scale, hybrid decentralized electrical power generation system for stationary and mobile embodiments, ranging from <1 kW to 10 kW to >10 kW in multiple units. Such systems find their application in stationary power supply units in residential, business, public and other local, networked or not, energy storage and recharging systems and similar mobile units.

### BACKGROUND OF THE INVENTION

The invention inscribes itself into the domain of small to medium scale hybrid intelligent, decentralized energy generation systems. It further provides a manufacturing concept with an unusually high degree of use of renewable energy over the total life cycle of the components and devices resulting from the invention. Furthermore the invention lends itself to the efficient co-exploitation of hybrid local, renewable wind and solar energy with other renewable energy sources such as solar photovoltaic, flat, parabolic, concentrated active or reflective, solar passive reflective, solar thermal, micro- and mini hydro-electric, geo-thermal, bio, bio-thermal, fuel-cells, electricity generating surfaces like pies-electric films or electro-constrictive polymers and others.

Such systems are known from various previous disclosures and are summarized in FIG. 1, Prior Art

For example, the document EP 08 156 970.9 of May 27, 2008 by the same applicant as shown in FIG. 1 a discloses an “Intelligent Decentralized Electrical Power Generation System” which is integrated in its entirety into the present application. In summary it discloses:
A substantially spherical multi-blade wind turbine (SSMBWT) that can function as a vertically axis wind turbine (VAWT) or a horizontal axis wind turbine (HAWT) with various performance enhancing properties, a structural, aerodynamic and ambient energy conversion support system, called aerodynamic backbone, a multimedia communication and networking system and a closed loop control system.
Several remaining problems have shown though that the invention according to document EP 08 156 970.9 of May 27, 2008 needs further innovation in order to be more efficient in operation and to be produced in a context of durable technology and recycling. Solutions to these remaining problems are hence integrated into the present disclosure while maintaining the substance of the disclosure of the document, as will be shown further on in the Description of the Invention.
   Other documents disclose hybrid decentralized electrical power generation systems.

For example document DE 10 2005 037 396 A1 of 08.08.2005, Gira Ulrike et al, as shown in FIG. 1b, discloses a solar-generator system for electrical energy generation combining solar and wind energy. The system is based on a solar panel (1), an axial rotor (2) which is supposed to rotate as a result from an upstream airflow in a chimney (3) and convert it into electricity, wherein the airflow is combined with a radial rotor (8) also made to turn by the up-stream airflow from the chimney as well as airflow resulting from wind coming from a more or less 90° angle with regards to the upstream flow in the chimney.
The problem with such a system is that it will not work as described in the disclosure. The energy content of the upstream air flow energy in a chimney is so little that it will not overcome the inertia of the described axial rotor, bearing, transmission shaft and generator in the dimensions as can be extrapolated from the dimensions of a chimney as disclosed.
At air-flow speeds occurring inside a chimney at 1 to 2 m/s the wind power corresponds only to 0.6 W/m² at 1 m/s air-flow and to 4.9 W/m² of wind power at 2 m/s, even at the standard air density and 15° C. ambient temperature, which does not apply in a chimney where the air density is much lower due to the higher temperature. Also most chimneys don't often have a cross-section of one m².
The formula for the power per m² in W (Watt) is 0.5*1.225*V³ where V is the speed of the air flow in m/s. (See http://windpower.org for details)
A further problem with such systems is that they will break down frequently anyway if built into chimneys of wood- or fuel firing heating systems because of the contamination with smoke particles.

Another document, FR 2 683 864 of 15.11.1991, by Djelouah Salah, as shown in FIG. 1c, describes a wind turbine for driving an electrical generator. In this system a chimney (2) is built around the mounting pole (1) of the wind turbine (3), thus forming a conduit wherein air heats up and rises if the chimney is exposed to the sun. The conduit has narrower diameters towards the top of the chimney in order to speed up the rising airflow. The blades of the wind turbine feature dual components for double action, axial for capturing the rising airflow and radial for capturing the wind from a substantially perpendicular direction with regards to the vertical axis of the turbine, pole and chimney. The blades are each built in 2 parts, one for axial and one for radial direction. The generator, dynamo or alternator can be located above the turbine or below in the conduit.
The problem with such a system again is that it will not work as described in the disclosure. The energy content of the upstream airflow energy in a chimney is so little that it will not overcome the inertia of the two component blades of the multi-blade turbine rotor, the bearings, transmission shaft and generator. The stepwise reduced diameters of the conduit do not help, the base energy content is so low, even if the rising air would reach 5 m/s, the power would still just correspond maximum to some 76 W per m² at any of the levels of diameters minus the losses.

Additionally the type of radial wind-turbine used accepts wind only from a basically horizontal direction, something which rarely exists around a chimney. By closing it off with a protection (15) as shown, it will further become unable to evacuate air at higher wind speeds and hence is inefficient.

Another document, WO 2007/007103 of Jul. 13, 2005 by Malcolm Little, as shown in FIG. 1d, discloses a roof tile (10), preferably a ridge tile, incorporating for example 3 wind-turbines (22) inside an internal void of a tile to harness energy from the wind and driving each a small generator for converting rotation into electricity. A solar collector (26) may be fitted on the outer walls of the tile. Several such tiles may be connected to form a larger system. The wind-turbine is of a spherical cowl type as they are common for mounting above chimneys. Lateral apertures (18) in the tile guide the wind to the rotors.
Again, the problem with such a system is the very low power generated by such cowls one hand due to their small diameter (35 cm) for the cowl specified which leads to a very small surface swept by the wind. The additional housing around the rotors and their confinement inside the tile reduce the efficiency even further.
Since these cowls are closed at the top due to the stamping production process chosen for these devices, they cannot evacuate the air efficiently at higher wind speeds, and the confinement inside the tile reinforces that disadvantage further.
Given the small surface available on top of ridge tiles, available photovoltaic solar collectors which may have an efficiency of 150 W/m² for one or more hours per day will not add much to the generation of electricity in this configuration.
Also, as the person skilled in the art will readily know, if placed close to each other in a confined space as shown in the document, the turbulences generated by the multitude of adjacent rotors will lead to hampering the proper function of each one.

A further document, DE 34 07 881 of Mar. 3, 1984 by Franz Karl Krieb, as shown in FIG. 1e, describes a hybrid energy generating system for household, business and agriculture. The system uses solar energy for both thermal and photovoltaic purposes and uses the naturally rising airflow resulting from the heat generated behind the surfaces of the solar converters. It captures wind energy from predominantly horizontal directions, re-directs and concentrates the resulting airflow into a vertical airflow which is combined with the rising airflow resulting from the heat generated at the solar converters. The combined airflow is guided to a vertical axis wind turbine (VAWT). The system obviously uses a significant number of ducting, venting, channelling, absorption, conversion and transmission elements, as well as energy storage components and system control and sensor elements.
The document is partly based on several aspects which in 1984 were still mainly in the realm of speculations, for example polycrystalline silicon photovoltaic cells or fuel cells.
Even by today's standards, the system according to the document would be extremely complicated and expensive to build. Re-directing wind-energy, even if coming solely from a horizontal direction as claimed, becomes very complicated and noisy at the exploitable wind-speeds, say as of 7 m/s with >200 W/m². At lower speeds than that, the losses within the system due to the ducting, re-directing etc will be significant as will be the overall weight. Additionally, as the person skilled in the art will know, horizontal winds occur mostly at higher altitudes in relatively flat topography and less or not at all around housing areas.
In fact, and as explained in the document, the system is not made to exploit winds at higher speeds and this despite its high level of complexity. Indeed as of a certain, unspecified limit of accepted wind-speed, safety flaps (called safety doors) are described to allow excess wind to blow off. The reasoning is that lower wind speeds occur more frequently and over longer periods of time. While this may be true for certain regions, the fact remains that the power of the wind increases at the power of 3 with its speed and that this law impacts any design. (Betz' Law, http://windpower.org)
Hence, and specifically such a complex and expensive system should be made to exploit winds from more than just horizontal directions and this over a wide range of wind speeds in order to justify the investment and allow a payback.
FIG. 2: Wind speed occurrence and energy content (Source: Sonne Wind & Wärme 5/2009) shows the correlation between the occurrence of different classes of wind-speed expressed in m/s and h/year and the corresponding energy in kWh/m² per year and per class of wind-speed again in m/s. It shows this for 2 regions: Austria with a high occurrence of low velocity wind (Föhn, 0 to 5 m/s) and Croatia with a high occurrence of higher velocity winds (Bora, 5 to >30 m/s). The implications for EP 08 156 970.9 and the other prior art documents are obvious:
First, an efficient wind turbine needs to be able to exploit wind speeds over a wide range, say from >3 to >30 m/s.

In summary all of these prior art documents overestimate substantially the energy content of low speed winds and try to exploit them with complex and heavy devices and systems. All of the documents propose embodiments that will not work at all or at best work only very inefficiently at the low wind speeds claimed for generating electricity.

### OBJECTIVES OF THE INVENTION

As is obvious from the graphs shown in FIG. 2, a first objective for an efficient wind turbine is to be able to exploit wind speeds over a wide range, say from >3 to >30 m/s. But applicant has found that a second point is by far more important in the creation of an efficient wind-turbine.

None of the prior art documents discloses wind-turbines with an efficient exploitation of anisotropic wind-energy, meaning wind coming from all sides including directions from above and from below the turbine and accepting wind-speeds over a wide practical range from >3 to >30 m/s. To function with this multitude of directions, range of speeds and respective annual durations in hours per m/s which occur worldwide has become the main objective of the invention.

Applicant has also found that in order to exploit such a range of speeds and range of directions a wind-turbine needs to have particular features which are best provided by a substantially spherical multi-blade wind turbine (SSMBWT) with a certain number and a particular type of multifunction blades.

Applicant has also found that in order to build a substantially spherical multi-blade wind turbine (SSMBWT) with such particular multifunction blades can result in very heavy structures which defeat the main objective. Additionally, traditional materials such as aluminium, stainless steel and composites lead to heavy constructions where sometimes the supporting surface and weight is superior to the wind exploiting surface and weight.

Hence a further objective hence was to design such a particular multifunction blade to be produced in one piece. Applicant has designed particular multifunction blades to be produced in an innovative material having a low specific weight and that can be processed to produce such a particular type of a multifunction blade in one piece and to produce several blades at a time.

A further objective was to produce such a particular multifunction blade in one piece in a material having an as far as possible positive balance in energy consumed to produce the material, to process it into the particular type of a multifunction blade and to recycle the blades with a maximum recuperation of energy without toxic by-products.

A further objective of the invention was to produce such a particular multifunction blade in one piece being able to be coated selectively with electro-generating materials, such materials being ferroelectric, meaning of polymer and ceramic nature and others being of photovoltaic nature, meaning application of film, coat or painted layers of such photovoltaic electro-generating material.

A last objective was to produce in a material that can be painted in colours that fit the environment of its installation and, if productive in the environment of installation, be coated or laminated by photovoltaic or ferroelectric polymer films.

Indeed as will be described later such a material was found and is produced with an environmentally friendly process releasing a fraction of CO2 compared to the materials that the cited prior art devices use, having excellent resilience and durability in harsh conditions and reasonable cost compared to other materials also allowing to produce the particular type of a multifunction blade.

Additionally the material offers a high value of recycling via incineration without toxic by-product and can be spray-painted in colours that provide an excellent visual integration into urban or countryside environments.

### SUMMARY OF THE INVENTION

The innovative substantially spherical multi-blade wind turbine (SSMBWT) according to the present invention is defined as follows. In accordance with a first embodiment of the invention, a substantially spherical multi-blade wind turbine (SSMBWT) (1) is provided that includes: (a) a plurality of multifunctional blades (2); and (b) a rotating axis (3) configured to rotate when the blades capture wind and for coupling to a power generator (4a), wherein each multifunctional blade (2) comprises three integrated functional sections (2a, 2b, 2c), each functional section having a different shape and being configured to guide and evacuate incoming airflow and to capture wind energy from different anisotropic directions.

In accordance with a second embodiment of the invention, the first embodiment is modified so that the functional sections consist of a top functional section (2a), a middle functional section (2b) and a bottom functional section (2c), wherein the top functional section (2a) is shaped to evacuate upward airflow coming from the middle functional section (2b), and to capture wind energy coming substantially or directly from above on the SSMBWT, and the middle functional section (2b) is shaped to guide incoming airflow to the top functional section (2a) for evacuating excess air flow, and to capture wind energy impacting from anisotropic directions on the SSMBWT except substantially or directly from above and directly from below the SSMBWT, and the bottom functional section (2c) is shaped to guide incoming airflow from below the SSMBWT to the middle functional section (2b) and to capture wind energy impacting substantially from anisotropic directions on the SSMBWT except substantially or directly from above. In accordance with a third embodiment of the invention, the second embodiment is further modified so that each blade section has an inner surface section and an outer surface section, wherein the top functional section (2a) has an inner wind swept surface section (2a1) for_evacuating upward air flow coming from the middle functional section (2b), and an outer swept surface section (2a2) for capturing wind energy coming substantially or directly from above and thus extending the range of the middle functional section (2b), wherein the middle functional section (2b) has an inner swept surface section (2b1) for guiding incoming air flow to the top functional section (2a) and evacuating excess air flow, and an outer swept surface section (2b2) capturing wind energy coming substantially from anisotropic directions except substantially or directly from above and directly from below the substantially spherical multi-blade wind turbine, and wherein the bottom functional section (2c) has an inner swept surface section (2c1) for guiding incoming air flow coming from below the substantially spherical multi-blade wind turbine to the middle functional section (2b), thus facilitating rotation, and an outer swept surface section (2c2) for capturing wind energy coming substantially from anisotropic directions except substantially or directly from above and facilitating rotation. In accordance with a fourth embodiment of the present invention, the second embodiment, or the third embodiment, is further modified so that the middle functional section (2b) has an inner radius and a particular shape such that it facilitates the upwash of airflow hitting this section after having traversed the body of the substantially spherical multi-blade wind turbine as well as facilitates its rotation through the upwardly directed action.

In accordance with a fifth embodiment of the present invention, the first embodiment is modified so that the substantially spherical multi-blade wind turbine (SSMBWT) further includes (c) a spoiler (6) arranged below the multifunctional blades so as to exploit wind and airflow coming from various directions from below the lowest blade line of the blade assembly of the substantially spherical multi-blade wind turbine (SSMBWT) (1). In accordance with a sixth embodiment of the present invention, the fifth embodiment is further modified so that the spoiler (6) is arranged at a distance H below the lowest blade line of the blade assembly, and wherein the spoiler (6) is adjustable with respect to the lowest blade line of the blade assembly so as to make the distance H variable.

In accordance with a seventh embodiment of the present invention, the first embodiment, the second embodiment, the third embodiment, the fourth embodiment, the fifth embodiment, and the sixth embodiment, are further modified so that blades are made of 2-component DCPD (dicyclopentadiene). In accordance with an eighth embodiment of the present invention, the first embodiment, the second embodiment, the third embodiment, the fourth embodiment, the fifth embodiment, the sixth embodiment, and the seventh embodiment are further modified so that the number of blades is preferably 5 to 6, more preferably 7 to 8, even more preferably 8 to 9.

In accordance with a ninth embodiment of the present invention, the fifth embodiment is further modified so that the spoiler comprises a plurality of through-holes operating as air-guiding sections (6a), wherein the number of air-guiding sections is one less than the number of blades (2) of the SSMBWT (1). In accordance with a tenth embodiment of the present invention, the first embodiment, the second embodiment, the third embodiment, the fourth embodiment, the fifth embodiment, the sixth embodiment, the seventh embodiment, the eighth embodiment, and the ninth embodiment, are further modified so that at least parts of the outer surface (22a) and of the inner surface (22b) of the blades (22) are machined to enhance the aerodynamic properties of the substantially spherical multi-blade wind turbine (SSMBWT) by reducing the drag of the blades. In accordance with an eleventh embodiment of the present invention, the first embodiment, the second embodiment, the third embodiment, the fourth embodiment, the fifth embodiment, the sixth embodiment, the seventh embodiment, the eighth embodiment, the ninth embodiment, and the tenth embodiment, are further modified so that an electro-active material is applied to the outer surface (22a) and the inner surface (22b) of the blades (22) to provide these with electro-active surface properties. In accordance with a twelfth embodiment of the present invention, the tenth embodiment or the eleventh embodiment is further modified so that the electro-active materials are photovoltaic and/or ferroelectric materials with which either the outer surface (22a) or the inner surface (22b), or both surfaces, of the blades (22) as well as the outer surface (66a) of the spoiler (6) are coated, laminated or otherwise selectively fitted therewith.

In accordance with a thirteenth embodiment of the present invention, the first embodiment is modified so that it further comprises a mounting pole (7) on which is fitted a housing (4a) containing an electrical generator (4), wherein the housing (4a) is shaped so as to be aerodynamic and to allow for an optimum air guiding, and the housing (4a) comprises longitudinal grooves (4b) arranged in its outer surface for guiding airflow and accelerating airflow into the air-guiding sections of the spoiler (6). In accordance with a fourteenth embodiment of the present invention, the first embodiment, the second embodiment, the third embodiment, the fourth embodiment, the fifth embodiment, the sixth embodiment, the seventh embodiment, the eighth embodiment, the ninth embodiment, the tenth embodiment, the eleventh embodiment, the twelfth embodiment, and the thirteenth embodiment, are further modified so that the substantially spherical multi-blade wind turbine (SSMBWT) further comprises spring-loaded or motorised fixtures (3a) for holding or releasing the blades (2) on the top and on the bottom part of the substantially spherical multi-blade wind turbine (SSMBWT) as a function of wind-speed and force on the blades (2) by closing or opening the space between the blades.

In accordance with a fifteenth embodiment of the present invention, an electrical power generating system is provided that includes (a) a substantially spherical multi-blade wind turbine SSMBWT according to anyone of the first embodiment, the second embodiment, the third embodiment, the fourth embodiment, the fifth embodiment, the sixth embodiment, the seventh embodiment, the eighth embodiment, the ninth embodiment, the tenth embodiment, the eleventh embodiment, the twelfth embodiment, the thirteenth embodiment, and the fourteenth embodiment; and (b) an airflow conduit element arranged below the substantially spherical multi-blade wind turbine and providing support for the substantially spherical multi-blade wind turbine, and wherein the airflow conduit element is in the shape of a flexible circular, curved, concave, convex, flat or otherwise shaped support unit supporting on its inside suitable gearing and fixtures including at least one electrical generator, wherein the airflow conduit element carries on its outer surface photovoltaic or other electricity generating materials and surfaces treated to facilitate the generation of electrical energy. In accordance with a sixteenth embodiment of the present invention, the fifteenth embodiment is further modified so that the housing is adapted to house one or more electrical generators (4x) in an axial stack packaging geometry still designed to be an optimum aerodynamically for air guiding within the spoiler (6).

### BRIEF DESCRIPTION OF THE DRAWINGS

Other features and advantages of the substantially spherical multi-blade wind turbine (SSMBWT) according to the present invention will become clear from reading the following description, which is given solely by way of a non-limitative example, thereby referring to the attached drawings in which:

FIG. 1 shows an overview of known systems from various previous disclosures,

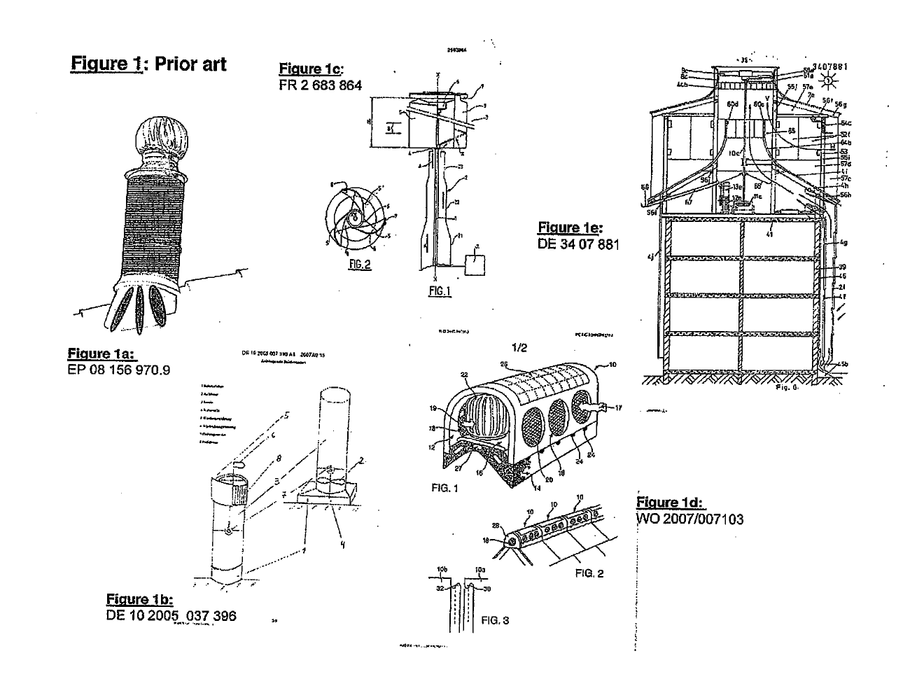

FIG. 2 shows graphs representing the wind speed occurrence and energy content (Source: Sonne Wind & Warme 5/2009),

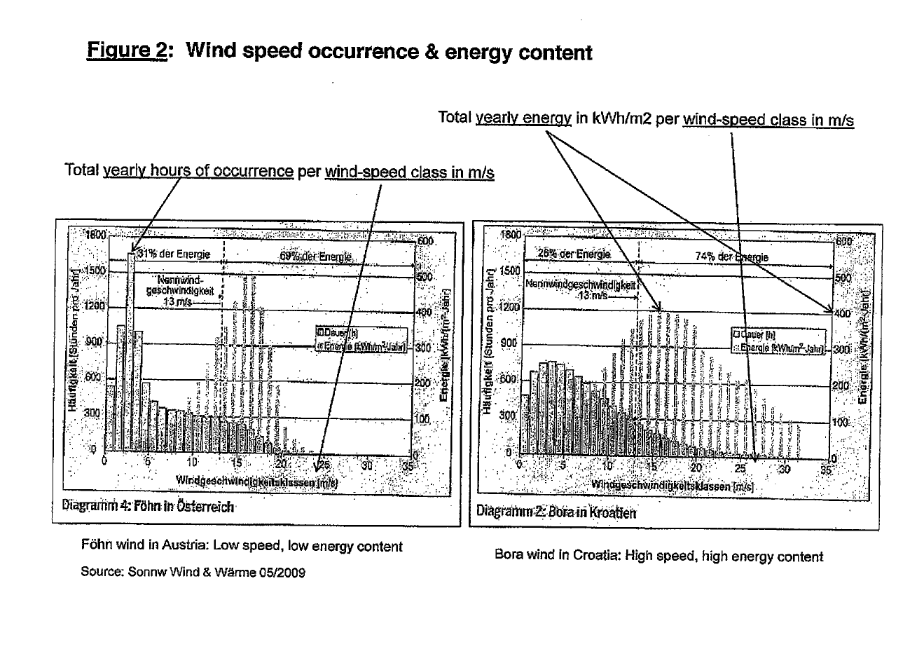

FIG. 3 shows an example of a substantially spherical multi-blade wind turbine (SSMBWT) according to the present invention,

FIG. 4 shows a substantially spherical multi-blade wind turbine (SSMBWT) having multifunctional blade sections to exploit wind-energy from anisotropic directions according to the present invention,

FIG. 5 shows a substantially spherical multi-blade wind turbine (SSMBWT) and exploitation of wind energy from underneath the substantially spherical wind-turbine according to the present invention,

FIG. 6 shows variants of the substantially spherical multi-blade wind turbine (SSMBWT) according to the present invention,

FIG. 7 shows a further variant of the present substantially spherical multi-blade wind turbine (SSMBWT) having blades exploiting wind-energy from anisotropic directions and using reflection of solar energy on specific photovoltaic blade sections from its spoiler, and

FIG. 8 shows further variants of the substantially spherical multi-blade wind turbine (SSMBWT) having adaptive blade positions exploiting wind-energy from anisotropic directions according to the present invention.

### DETAILED DESCRIPTION OF THE INVENTION

Document EP 08 156 970.9 of May 27, 2008 by the same applicant which discloses an “Intelligent Decentralized Electrical Power Generation System” is integrated in its entirety into the present application. In summary this document discloses:
A substantially spherical multi-blade wind turbine (SSMBWT) that can function as a vertically axis wind turbine (VAWT) or a horizontal axis wind turbine (HAWT).
A substantially spherical multi-blade wind turbine (SSMBWT) that offers a swept surface basically twice as large as HAWT's of the same diameter.
A substantially spherical multi-blade wind turbine (SSMBWT) that has dimensions from 0.4 to >1 m in diameter.
A substantially spherical multi-blade wind turbine (SSMBWT) that has a second stage added to increase efficiency revolutions over time.
An airflow conduit element called aerodynamic backbone, being arranged below the substantially spherical multi-blade wind-turbine (SSMBWT) or alongside it. The terminology for this element relates to living creatures, it is a partially active, partially passive supporting structure that houses vital organs of the system that it supports and contributes to energy generation. This element is constituted by a substantially hollow, vertical, horizontal or otherwise arranged support for the substantially spherical multi-blade wind turbine (SSMBWT). It is built in the shape of a flexible circular, curved, concave, convex, flat or otherwise shaped support unit supporting on its inside suitable gearing and fixtures including at least one electrical generator and carrying on its outside photovoltaic or other electricity generating materials and surfaces treated to facilitate the generation of electrical energy.
The term flexible in this context means that the airflow conduit element called aerodynamic backbone can take different geometrical positions with regards to and independently of the substantially spherical multi-blade wind-turbine (SSMBWT).
A device and system where inside the aerodynamic backbone, being arranged below the substantially spherical multi-blade wind-turbine (SSMBWT) or alongside it, serving as a substantially hollow vertical, horizontal or otherwise arranged support for the substantially spherical multi-blade wind turbine (SSMBWT), is further used to house the components for the conversion of wind to electrical energy. These may be devices such as an alternator, a DC motor, a mechanical rotation transmission unit such as a CVT (Continuously variable transmission) in between the wind-turbine and the components for conversion of wind to electrical energy.
A substantially spherical multi-blade wind turbine (SSMBWT) that can itself at least contain or consist of surfaces able to convert or been made to convert wind as well as solar power into electrical energy additionally to the conventional rotational mechanical/electrical energy conversion given by the substantially spherical multi-blade wind turbine (SSMBWT) and a suitable electricity generating element.
A substantially spherical multi-blade wind turbine (SSMBWT) that uses blades which are produced in a way to offer a larger surface to the wind than given by their simple geometrical dimension and that are constructed in a way to accept wind from anisotropic directions.
A substantially spherical multi-blade wind turbine (SSMBWT) where the blades are surface treated to enhance aerodynamic performance.
A substantially spherical multi-blade wind turbine (SSMBWT) based hybrid system that incorporates state of the art multi-media communication and networking technologies according to the co-pending application WO 2007/022911 in the name of the present Applicant and entitled “Multilevel Semiotic and Fuzzy Logic User and Metadata Interface Means for interactive Multimedia System having Cognitive Adaptive Capability”.

According to the present invention, a substantially spherical multi-blade wind turbine (SSMBWT) having blades exploiting wind-energy from anisotropic directions is provided and which introduces further innovations relating to the substantially spherical multi-blade wind turbine (SSMBWT) with a certain number of a particular type of multifunction blades corresponding to the objectives described above.

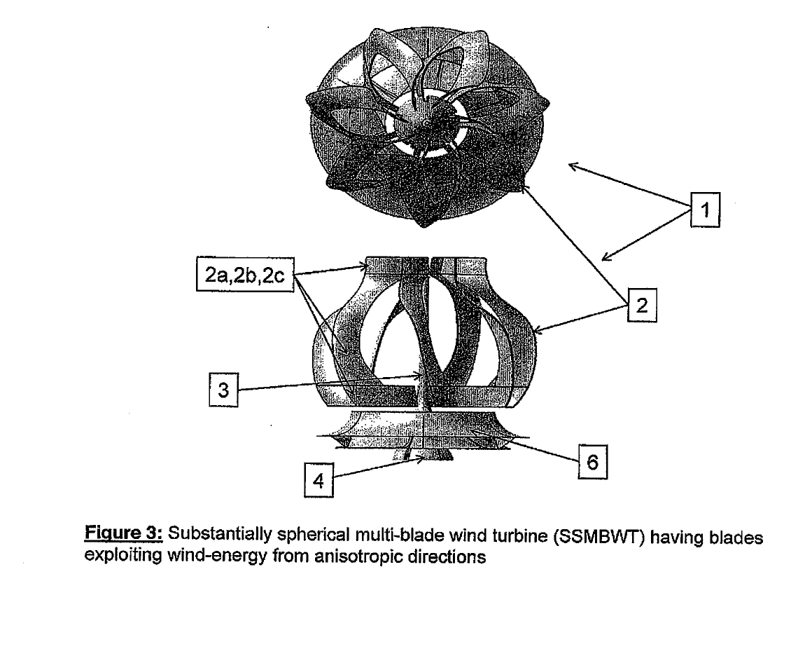

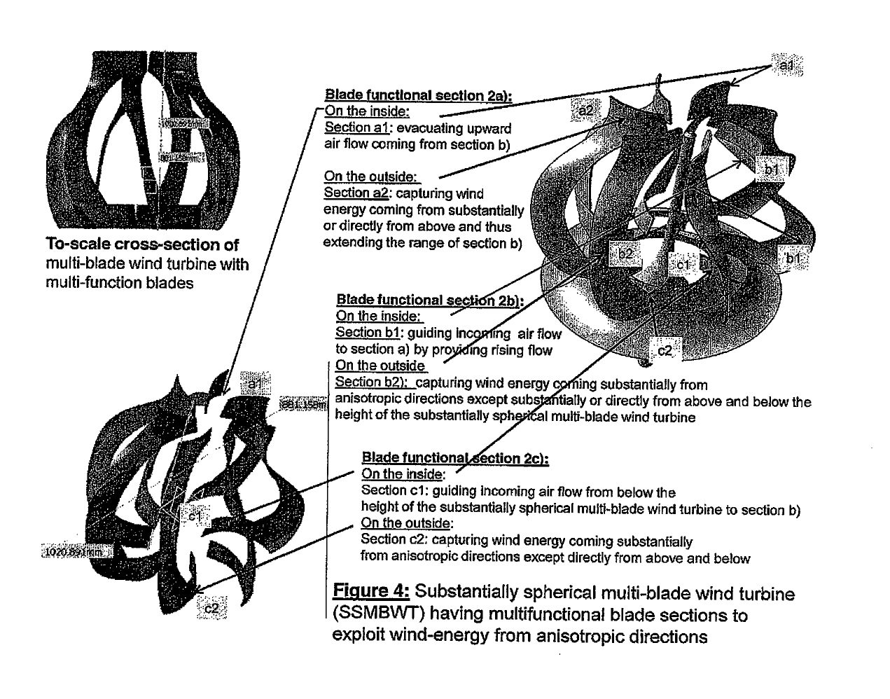

FIG. 3 shows an example of a substantially spherical multi-blade wind turbine (SSMBWT) according to the present invention.
A substantially spherical multi-blade wind turbine with a certain number of blades, preferably 5 to 6, more preferably 7 to 8, even more preferably 8 to 9 and in the particular type of multi-function blade most preferably 7 blades. Indeed applicant has found that a lower number of the particular type of multi-function blades, for example 9 instead of 18 such blades, offers no significant degradation of aero-generator performances and that an uneven numbers of such blades offer a slight advantage, due to better air evacuation and surface recuperation for air flowing from the blade at the entrance side and the blade at the exit side of the substantially spherical multi-blade wind turbine.
A substantially spherical multi-blade wind turbine with multi-function blades that are produced in once piece but have 3 distinct functional sections, themselves having different functions depending on their inside or outside swept surfaces, thus allowing to efficiently exploit anisotropic wind from above, around and from underneath.
As shown in FIG. 3, the substantially spherical multi-blade wind turbine (1) consists of a number of blades (2), 7 in this embodiment, having at least 3 functional sections (2a, 2b, 2c) and being fixed to a rotating axis (3) which rotates with the blades according to the wind speed and in one direction.
The different fixations between rotating and fixed elements are not shown in the various Figures in order not to clutter the drawings and because their need and implementation is obvious to the skilled person. This principle is maintained throughout the document.
The rotating axis is further mechanically connected to a rotor inside an electrical power generator (4). Underneath the blade assembly and not fixed to the rotating axis is a fixed, non rotating spoiler (6) to guide wind and other air flow from various directions underneath the blade assembly to the particular blade sections 2c as will be shown later.
Indeed FIG. 4: “Substantially spherical multi-blade wind turbine (SSMBWT) having multifunctional blade sections to exploit wind-energy from anisotropic directions” shows in more detail the blade sections of the substantially spherical multi-blade wind turbine (SSMBWT) according to the present invention. As mentioned above, each blade consists of three specific functional sections 2a, 2b and 2c, meaning that each section has a different function and shape adapted for that function with respect to exploiting impacting wind energy.

1. Functional Section 2a):
On the inside of swept surface section 2a): evacuating upward air flow coming from section 2b)
On the outside of swept surface section 2a): capturing wind energy coming substantially or directly from above and thus extending the range of section 2b)

2. Functional Section 2b):
On the inside of swept surface section 2b): guiding incoming air flow to section 2a) and evacuating excess air flow,
On the outside of swept surface section 2b): capturing wind energy coming substantially from anisotropic directions except substantially or directly from above and directly from below the substantially spherical multi-blade wind turbine.
The inner radius of section 2b) and its particular shape facilitate the upwash of airflow hitting this section after having traversed the body of the substantially spherical multi-blade wind turbine as well as they facilitate its rotation through the upwardly directed action.

3. Functional Section 2c:
On the inside of swept surface section 2c): guiding incoming air flow coming from below the substantially spherical multi-blade wind turbine to section 2b)
On the outside of swept surface section 2c:) capturing wind energy coming substantially from anisotropic directions except substantially or directly from above

The complete wind-turbine blade in harmony with its 3 functionalities over a wide range of wind-speeds and the correct number of blades is at the core of the present invention.

However the objective of exploiting wind energy also from below the substantially spherical wind-turbine may be further improved so as to achieve further innovation than is provided by the substantially spherical wind-turbine disclosed up to now in the cited document EP 08 156 970.9 of May 27, 2008 which is integrated into the present application and by the particular type of multi-function blades disclosed above.

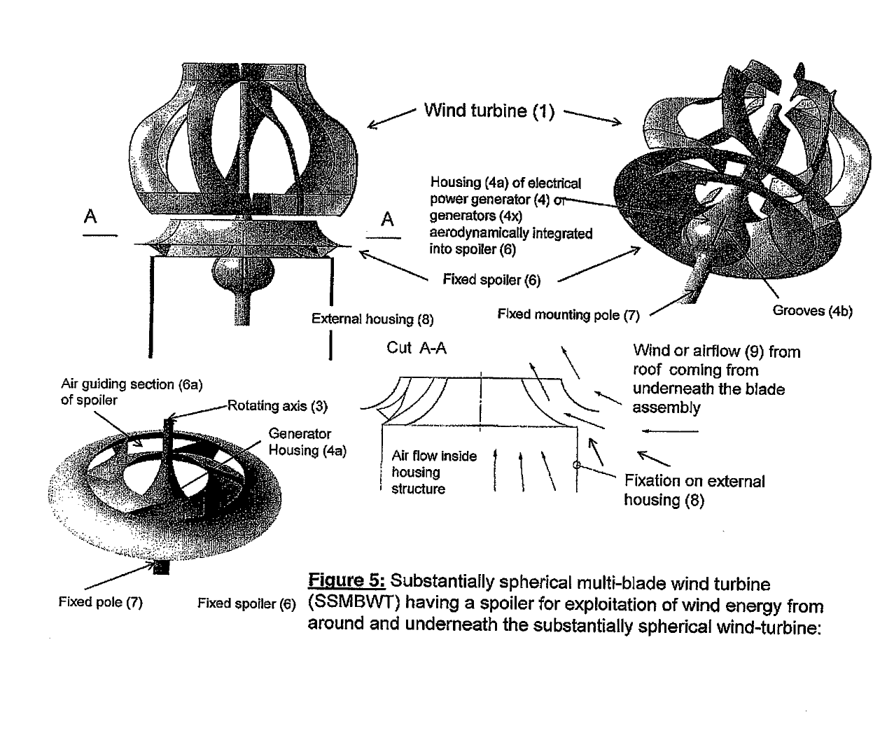

The solution to this objective is shown in FIG. 5: Substantially spherical multi-blade wind turbine (SSMBWT) and exploitation of wind energy from underneath the substantially spherical wind-turbine:

Again in FIG. 5 as in other figures and in order not to clutter the drawings the fixation of the blades and other parts with the rotating axis (3) are not shown.

FIG. 5 shows a substantially spherical multi-blade wind turbine (SSMBWT) (1) that integrates a housing (4a) of the components (rotor, stator, bearings, connectors etc) for the electrical generator (4) into a fixed spoiler (6) mounted on a fixed pole (7) and an external housing (8), these elements forming together the aerodynamic backbone. The housing (4a) of the electrical generator (4) is designed to be aerodynamically an optimum air guiding within the spoiler (6) designed to exploit wind and airflow (9) coming from various directions from below the lowest blade line of the blade assembly of the substantially spherical multi-blade wind turbine (SSMBWT) (1). The housing may be adapted to house one or more electrical generators (4x) in an axial stack packaging geometry still designed to be an optimum aerodynamically for air guiding within the spoiler (6). Spoiler (6) has one less air-guiding section (6a) than the substantially spherical multi-blade wind turbine (SSMBWT) (1) has blades (2). Hence for 7 blades as in the embodiment shown throughout the present document there will be 6 air-guiding sections (6a). This is to assure that any air guiding section has a larger opening than the distance between the blades and avoids unnecessary turbulences and losses. Also the housing (4a) of the electrical generator (4) has particular vertical grooves (4b) designed to provide an acceleration into each of the air-guiding sections (6a), hence an equal number of grooves as air-guiding sections.

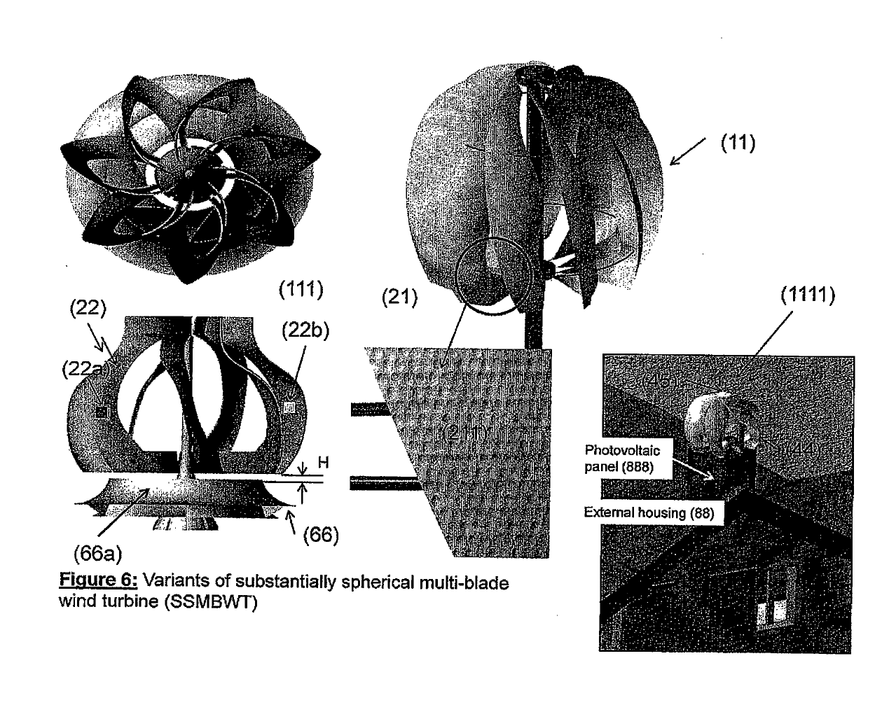

### FIG. 6: Variants of Substantially Spherical Multi-Blade Wind Turbine (SSMBWT)

FIG. 6 introduces a first variant (11) where the blades (21) are surface treated to enhance aerodynamic performance. This surface treatment can be applied over the entire surface or specifically as shown (211) on the flank of the blade turning out of the wind during rotation in order to reduce the drag and not to produce a significant vortex along that flank when turning out of the wind, but many tiny vortexes, hence less losses.

FIG. 6 further introduces a second variant (111) where the distance H between the lowest line of the blades (22) and the upper line of the spoiler (66) is adjustable. This feature allows optimizing the performance of exploiting wind and air flow from below the blades to the type and speed of wind and airflow prevalent at the site of installation, the height of the pole, the type of roof, flat or inclined and other conditions that may require such a tuning.

FIG. 6 further introduces in the same variant (111) a surface treatment destined to enhance aerodynamic properties by treating outer surface (22a) and an inner surface (22b) of the blades (22) of the substantially spherical multi-blade wind turbine (SSMBWT) as well as the outer surface (66a) of spoiler (66) with electro-active surface properties. Such electro-active surface properties enhance the aerodynamic properties of the substantially spherical multi-blade wind turbine (SSMBWT) by adding energy recuperation to the same swept surface which cannot be anticipated by Betz' law. Betz' law stipulates that the extractable power per m² in W (Watt) is 0.5*1.225*V³ where V is the speed of the airflow in m/s. (See http://windpower.org for details). This is true if the structure exploits only energy contained in the wind. Indeed, as is known in the art, the same surfaces exposed to the wind can be coated by electro-active materials. Such electro-active properties relate to photovoltaic or ferroelectric materials with which either outer surface (22a) or inner surface (22b) or both surfaces of the blades (22) as well as the outer surface (66a) of spoiler (66) are coated, laminated or otherwise selectively fitted with. The selection can depend on the installation site, on the degree of windy incidence ferroelectric materials may be used predominantly, in a more sunny environment photovoltaic materials may prevail. In some cases, and this is a particular advantage of the present application, all of the inner surface (22b) of the blades (22) can be coated with ferroelectric material and the outer surface (22b) of the blades (22) can be coated with photovoltaic materials.

As will be explained further the material and manufacturing process chosen for the above components of the substantially spherical multi-blade wind turbine (SSMBWT) are suitable for selectively applying such electro-active surface properties to the inner (22b) and outer (22a) surfaces of blades (22).

FIG. 6 further introduces a variant (1111) where 2 generators (44) and (45) are built-in. This can be the case for larger systems or where the system works in closed look with the photovoltaic panels as disclosed in the document EP 08 156 970.9 of May 27, 2008 which is integrated into the present application. Variant (1111) also shows the external housing (88) covered with a photovoltaic panel (888) as disclosed in the cited document EP 08 156 970.9.

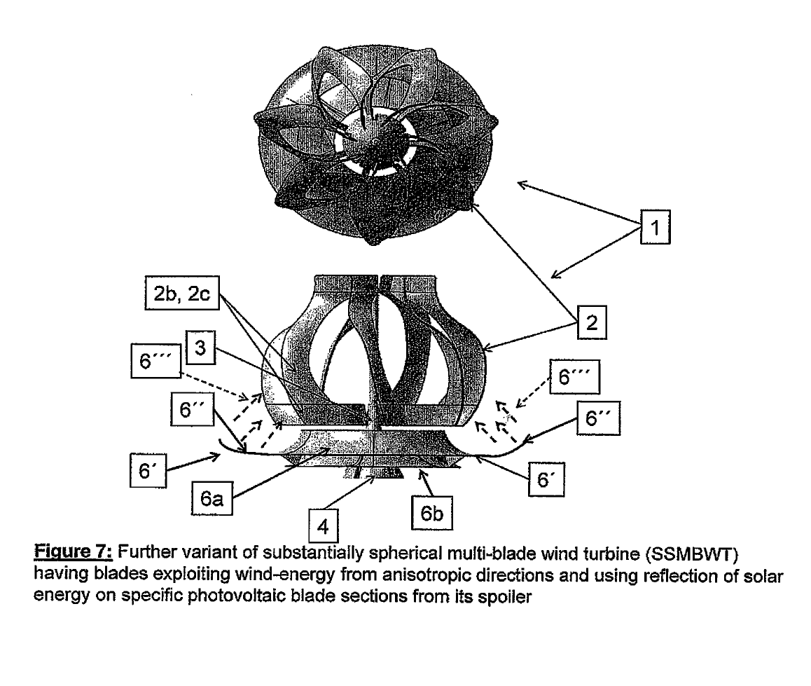

FIG. 7: Further Variant of Substantially Spherical Multi-Blade Wind Turbine (SSMBWT) Having Blades Exploiting Wind-Energy from Anisotropic Directions and Using Reflection of Solar Energy on Specific Photovoltaic Blade Sections from its Spoiler.

FIG. 7 introduces an inventive construction allowing to use a component, a spoiler (6) which is designed to increase aerodynamically the exploitation of wind energy coming from around and below a substantially spherical multi-blade wind turbine (SSMBWT) in such a way that the exploitation of solar energy falling on that same substantially spherical multi-blade wind turbine (SSMBWT) can also be increased. In fact the middle surface line (6′) separating upper (6a) and lower part (6b) of spoiler (6) is curved upwards in an optimal curvature in order to form a larger surface (6″) reflecting incoming solar irradiation (6′″) on spoiler (6) to the parts (2b) and partly (2c) of blades (2) of the substantially spherical multi-blade wind turbine (SSMBWT) (1).

Parts (2c) may be partially fitted with ferroelectric material instead of photovoltaic material depending on the importance of upwind.

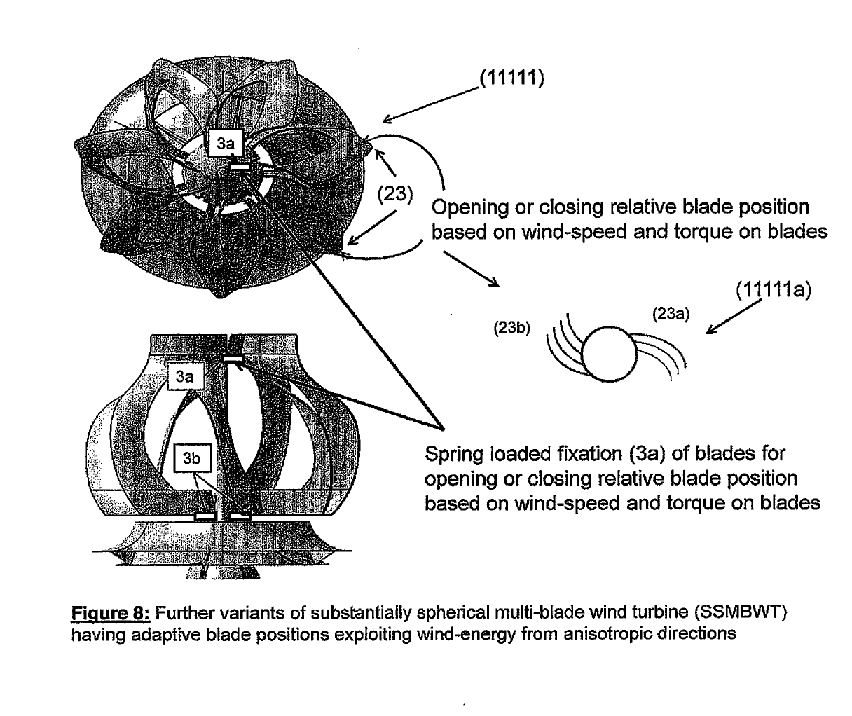

FIG. 8: Further Variants of Substantially Spherical Multi-Blade Wind Turbine (SSMBWT) Having Adaptive Blade Positions Exploiting Wind-Energy from Anisotropic Directions

FIG. 8 further introduces a variant (11111) where spring-loaded or motorized fixtures (3a) hold or release the blades (23) on the top and the bottom part of the substantially spherical multi-blade wind turbine (SSMBWT) (1) in function of wind-speed and force on the blades (23), thus closing the space between the blades (23) at higher wind speeds (e.g. >25 to 30 m/s) in order to continue generating electricity without stopping the wind-turbine at these high wind speeds. In the case of 7 blades 3 blades would move closer together in one segment of rotation (23a) and 4 blades would move closer in the other segment (23b), thus forming a multi-blade Savonius like configuration, as the skilled person can imagine and as shown in FIG. 8 with embodiment (11111a). The narrower space between the blades will decrease the efficiency of air evacuation, hence reduce the speed of rotation but permit to continue to rotate at these higher wind-speeds and to extract energy at these extremely valuable wind-speeds in terms of energy content.

It will be clear from this description that not only does the inventive, substantially spherical multi-blade wind turbine (SSMBWT) exploit wind-energy from basically all isotropic wind directions but is also configured to increase on the same surface used for exploiting renewable wind-energies by the additional exploitation of solar and ferroelectric energies.

### Manufacturability

The ecological and economical manufacturability of the substantially spherical multi-blade wind turbine (SSMBWT) is an important issue in the context of device destined to produce energy from renewable sources such as wind and sun. Applicant has studied the various materials and manufacturing processes as well as the respective ecological balances in terms of CO2 production from well to blade and in terms of recycling processes. Cost pressures to produce such a complex component such as the multifunctional blades of substantially spherical multi-blade wind turbine (SSMBWT) are an additional problem, same as strength, resilience, resistance to extreme temperature changes, UV resistance, specific weight, wind impact, abrasion due to dust, sand etc.

Applicant has found that a 2-component DCPD (dicyclopentadiene) produced by standard RIM (Reaction Injection Moulding) processes with widely available high pressure mixing RIM machines is the most attractive solution, compared to carbon fibre, composites or aluminium. Blades of >2.5 m in length can be manufactured with today's technology. Hence the limitation is not in the available machines, but in the moulds and in process control issues such as dosage of raw material (DCPD), temperature, pressure etc, which need to be defined and controlled as in any manufacturing process. This however corresponds to the normal evolution of any manufacturing technology and does not constitute an impediment to the production of the blades in one piece for the substantially spherical multi-blade wind turbine (SSMBWT) according to the present disclosure.

Hence an SSMBWT, a substantially spherical multi-blade wind turbine (SSMBWT) of >3 m in diameter with blades made in one piece can be envisioned. Such a device at 7 blades would turn at 11.4 RPM at a wind speed of U=2.8 m/s in continuous, stable wind speed, would have an acceleration of 0 RPM to 10 RPM in 36.5 s. The torque at the acceleration would be some 9.0 Nm. The torque calculated at a constant RPM of 11.4 would be 0.5 à 1.5 Nm with 7 blades, a reasonable oscillation of torque during continuous revolution.

Additionally DCDP has an excellent energy balance, the total energy consumed to produce a part is 4 times lower than Polypropylene and 10 times lower that Polycarbonate. In recycling through incineration DCDP's allow a very high energy recuperation without toxic by-products.

DCDP is available under the brandname Telene™ through RIMTEC and their subsidiaries.

The multi-function blades of the substantially spherical multi-blade wind turbine (SSMBWT) can be made in one piece and several pieces can be made in one moulding step. The blades can be painted in any colour, for example approaching the colour of the roof or building where the substantially spherical multi-blade wind turbine (SSMBWT) is to be installed.

As far as disclosed in FIG. 6: Variants of substantially spherical multi-blade wind turbine (SSMBWT) and fitting the inner (22b) or outer (22a) surface of DCDP made blades (22) with electro-active ferroelectric polymer surfaces and as cited for the variants discussed are concerned, such polymers like PVDF and their co-polymers P(VDF-TFE) are industrially available. PVDF, a Ferro-electric polymer, Polyvinylidene fluoride with its low density and low cost compared to the other fluoropolymers and its availability in the form of sheets, tubing, films, plate etc are positive with regards to its combination with DCDP. PVDF can be injected, moulded or welded and is commonly used in the chemical, semiconductor, medical and defence industries, as well as in lithium ion batteries. PVDF is available under a number of tradenames.

As far as disclosed in FIG. 6: Variants of substantially spherical multi-blade wind turbine (SSMBWT) and fitting outer (22a) surface of DCDP made blades (22), with electro-active photovoltaic surfaces the person skilled in the art will be aware of a variety of flexible photovoltaic cell films that can be applied to the blades.

However the specific RIM DCDP manufacturing process of the blades as explained before results in a particular preference for ink-jet type printing process of the layers constituting an electro-active, photovoltaic cell layer on the blade (22). Indeed this process can use the CNC (Computer Numerical Control) data used for machining the mould for the blades and hence control the inkjet heads and the printing process for a blade (22) in one piece and within tight tolerances based on its original DCDP manufacturing CNC data. As the skilled person can observe, the method will also be allow to replicate a blade surface treated to enhance aerodynamic performance as specifically shown in FIG. 6: Variants of substantially spherical multi-blade wind turbine (SSMBWT) and also on elements (211) on the flank of the blade (21). Hence the accumulation of both the aerodynamic improvement and the additional energy generation is achieved through the present invention.

Having described now the preferred embodiments of this invention, it will be apparent to one of skill in the art that other embodiments incorporating its concept may be used. It is felt, therefore, that this invention should not be limited to the disclosed embodiments, but rather should be limited only by the scope of the appended claims.

1-16. (canceled)

17. A substantially spherical multi-blade wind turbine, comprising:
(a) a plurality of multifunctional blades, wherein each multifunctional blade comprises three integrated functional first sections, wherein each functional first section includes a top functional second section, a middle functional second section, and a bottom functional second section, wherein each second section has a different aerodynamic shape and is configured to guide and evacuate incoming airflow and to capture wind energy from different anisotropic directions,
wherein the top functional second section is aerodynamically shaped to evacuate upward airflow coming from the middle functional second section and to capture wind energy coming substantially or directly from above on the wind turbine, and wherein the top functional second section has an inner windswept aerodynamic surface section for evacuating upward air flow coming from the middle functional second section, and an outer windswept aerodynamic surface section for capturing wind energy coming substantially or directly from above and thus extending a range of the middle functional second section,
wherein the middle functional second section is aerodynamically shaped to guide incoming airflow to the top functional second section for evacuating excess air flow and is aerodynamically shaped to capture wind energy impacting from anisotropic directions on the wind turbine except substantially or directly from above and directly from below the wind turbine, and wherein the middle functional second section has an inner swept aerodynamic surface section for guiding incoming air flow to the top functional second section and for evacuating excess air flow and an outer windswept aerodynamic surface section capturing wind energy coming substantially from anisotropic directions except substantially or directly from above and directly from below the substantially spherical multi-blade wind turbine, and
wherein the bottom functional second section is aerodynamically shaped to guide incoming airflow from below the wind turbine to the middle functional second section and to capture wind energy impacting substantially from anisotropic directions on the wind turbine except substantially or directly from above, and wherein the bottom aerodynamic functional section has an inner swept surface section for guiding incoming air flow coming from below the substantially spherical multi-blade wind turbine to the middle functional second section, thus facilitating rotation, and an outer swept surface section for capturing wind energy coming substantially from anisotropic directions except substantially or directly from above and facilitating rotation.

18. A substantially spherical multi-blade wind turbine according to claim 17, wherein the middle functional second section has an inner radius and a particular aerodynamic shape that facilitates an upwash of airflow hitting the middle functional second section after having traversed a body of the substantially spherical multi-blade wind turbine and that further facilitates rotation through an upwardly directed action.

19. A substantially spherical multi-blade wind turbine according to claim 17, further comprising:
(b) a spoiler arranged below the multifunctional blades so as to exploit wind and airflow coming from various directions from below a lowest blade line of a blade assembly comprising the plurality of blades of the substantially spherical multi-blade wind turbine.

20. A substantially spherical multi-blade wind turbine according to claim 19, wherein the spoiler is arranged at a distance H below the lowest blade line of the blade assembly, and wherein the spoiler is adjustable with respect to the lowest blade line of the blade assembly so as to make the distance H variable.

21. A substantially spherical multi-blade wind turbine according to claim 17, wherein the blades are made of 2-component dicyclopentadiene.

22. A substantially spherical multi-blade wind turbine according to claim 19, wherein the spoiler comprises a plurality of through-holes formed therein and operating as air-guiding sections, wherein the number of air-guiding sections is one less than the number of blades of the plurality of blades of the wind turbine.

23. A substantially spherical multi-blade wind turbine according to claim 17, wherein at least parts of an outer surface and of an inner surface of the blades are machined to enhance aerodynamic properties of the substantially spherical multi-blade wind turbine by reducing drag of the blades.

24. A substantially spherical multi-blade wind turbine according to claim 23, wherein an electro-active material is applied to the outer surface and to the inner surface of the blades to provide these surfaces with electro-active surface properties.

25. A substantially spherical multi-blade wind turbine according to claim 24, wherein said electro-active material is a photovoltaic material, or a ferroelectric material, or a photovoltaic and ferroelectric material, with which either the outer surface or the inner surface or both the outer and the inner surfaces of the blades, as well as an outer surface of the spoiler, are coated, laminated or otherwise selectively fitted with said electro-active material.

26. A substantially spherical multi-blade wind turbine according to claim 19, further comprising:
(b) a mounting pole on which is fitted a housing containing an electrical generator, wherein the housing is shaped so as to be aerodynamic and to allow for an optimum air guiding, and the housing comprises longitudinal grooves arranged in an outer surface of the housing for guiding airflow and accelerating airflow into air-guiding sections of the spoiler.

27. A substantially spherical multi-blade wind turbine according to claim 17, further comprising
(b) spring-loaded or motorised fixtures for holding or releasing the blades on a top part and on a bottom part of the substantially spherical multi-blade wind turbine as a function of wind-speed and force on the blades by closing or opening a space between the blades.

28. An electrical power generating system comprising:
(A) a substantially spherical multi-blade wind turbine according to claim 17; and
(B) an airflow conduit element arranged below said substantially spherical multi-blade wind turbine and providing support for said substantially spherical multi-blade wind turbine, wherein said airflow conduit element is in the shape of a flexible circular, curved, concave, convex, flat or otherwise shaped support unit supporting on an inside thereof suitable gearing and fixtures including at least one electrical generator,
wherein said airflow conduit element carries an outer surface photovoltaic or other electricity generating material, and surfaces treated to facilitate the generation of electrical energy.

29. An electrical power generating system according to claim 28, wherein a housing is adapted to house one or more electrical generators in an axial stack packaging geometry that is configured to be an optimum aerodynamically for air guiding within the spoiler.

30. A substantially spherical multi-blade wind turbine according to claim 18, wherein the blades are made of 2-component dicyclopentadiene.

31. A substantially spherical multi-blade wind turbine according to claim 19, wherein the blades are made of 2-component dicyclopentadiene.

32. A substantially spherical multi-blade wind turbine according to claim 20, wherein the blades are made of 2-component dicyclopentadiene.
